(19) United States
(12) Patent Application Publication
(10) Pub. No.: US 2018/0367420 A1
(43) Pub. Date: Dec. 20, 2018

(54) AUTOMATED RESOLUTION

(71) Applicant: Microsoft Technology Licensing, LLC, Redmond, WA (US)

(72) Inventors: Ashleigh Patricia Conway, Blackrock (IE); Darren Doyle, Dublin (IE); Terry Farrell, Dublin (IE)

(73) Assignee: Microsoft Technology Licensing, LLC, Redmond, WA (US)

(21) Appl. No.: 15/622,854

(22) Filed: Jun. 14, 2017

(51) Int. Cl. H04L 12/24; H04L 29/08

(52) U.S. Cl. CPC H04L 41/5022; H04L 41/069; H04L 41/0816; H04L 41/5009; H04L 41/0672; H04L 67/16

(57) ABSTRACT

Systems and methods are disclosed for automated resolution. In one implementation, a first notification is received. Such a notification is associated with a first instance of a service as provided to a first user. In response to receipt of the first notification, a first action is initiated with respect to the first instance of the service as provided to the first user. A second notification is received. Such a notification is associated with a second instance of the service as provided to a second user. Based on the first action initiated with respect to the first instance of the service as provided to the first user, a second action is initiated. Such a second action can be initiated in response to receipt of the second notification. The second action can also be initiated with respect to the second instance of the service as provided to the second user.

### TECHNICAL FIELD

Aspects and implementations of the present disclosure relate to data processing and, more specifically, but without limitation, to automated resolution.

### BACKGROUND

Various services and applications can be disseminated and managed via a centralized distribution platform/framework. Such a platform can enable a developer to disseminate an application and/or make a service available to numerous users. Various errors and outages can occasionally occur with respect to such services/applications.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

In one aspect of the present disclosure, Systems and methods are disclosed for automated resolution. In one implementation, a first notification is received. Such a notification is associated with a first instance of a service as provided to a first user. In response to receipt of the first notification, a first action is initiated with respect to the first instance of the service as provided to the first user. A second notification is received. Such a notification is associated with a second instance of the service as provided to a second user. Based on the first action initiated with respect to the first instance of the service as provided to the first user, a second action is initiated. Such a second action can be initiated in response to receipt of the second notification. The second action can also be initiated with respect to the second instance of the service as provided to the second user.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 is a flow chart illustrating a method, in accordance with an example embodiment, for automated resolution.

FIGS. 3A and 3B illustrate example scenarios described herein, according to an example embodiment.

FIGS. 4A and 4B illustrate example scenarios described herein, according to an example embodiment.

FIG. 5 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to automated resolution.

It can be appreciated that various digital distribution platforms enable developers to distribute and/or provide access to various applications, services, etc. While such frameworks can be effective in distributing such services/applications to numerous users, existing platforms are often ineffective with respect to addressing or resolving events such as service outages, installation failures, system crashes, etc. Additionally, it may also be challenging for developers of an application/service to directly address and/or attempt to resolve such issues. For example, a small team of developers of a service utilized by many users is unlikely to be able to address service issues, errors, etc. originating from many users on an individual basis. Additionally, developers can have many options to resolve such issues and it may be difficult for a developer to determine which option/approach is best suited for a particular issue, situation, user, etc.

Accordingly, described herein in various implementations are technologies, including methods, machine readable mediums, and systems, that enable automated resolution. The described technologies can identify an event such as the occurrence of a service outage, interruption, application crash, etc. Having identified such a service outage, various actions can be initiated. e.g., with respect to those users affected by the outage, crash, etc. The particular action(s) initiated (e.g., adding a free month to a user's subscription, providing access to additional functionality, providing a refund of fees paid by a user, etc.) can be selected based on various resolution parameters. Such parameters can reflect an approach or objective with respect to which a developer wishes to resolve such issues (e.g., prioritizing customer satisfaction, subscription revenue generated, etc.).

Additionally, the results of such actions can be monitored, based upon which an effectiveness (e.g., an effectiveness score, rank, etc.) of a particular action/resolution can be determined. For example, subsequent user activity can reflect whether a particular action/resolution (e.g., providing a free week of service) was effective in achieving a result sought by the developer (e.g., subscriber retention). Subsequent service outages, etc., can then be approached/addressed based on such determinations. For example, actions/resolutions determined to be effective can be applied in future scenarios while ineffective (or sub-optimal) actions can be adjusted or replaced, as described herein. Developers can thus ensure that service outages, interruptions, and other such issues are addressed in an automated and efficient manner. In doing so, the experience of those users affected by the outage can be improved (e.g., by being notified of and/or receiving such a resolution without needing to initiate contact with the developer). The developer also need not be burdened with addressing numerous user complaints, requests, etc., individually. Additionally, the developer can be provided with data, feedback, recommendations, etc., with respect to the results/effectiveness of various actions/resolutions. Such information can further enable the developer to adjust or refine various options in order to achieve a desired result (e.g., subscriber retention, etc.).

It can therefore be appreciated that the described technologies are directed to and address specific technical challenges and longstanding deficiencies in multiple technical areas, including but not limited to application distribution, service restoration, and error resolution. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

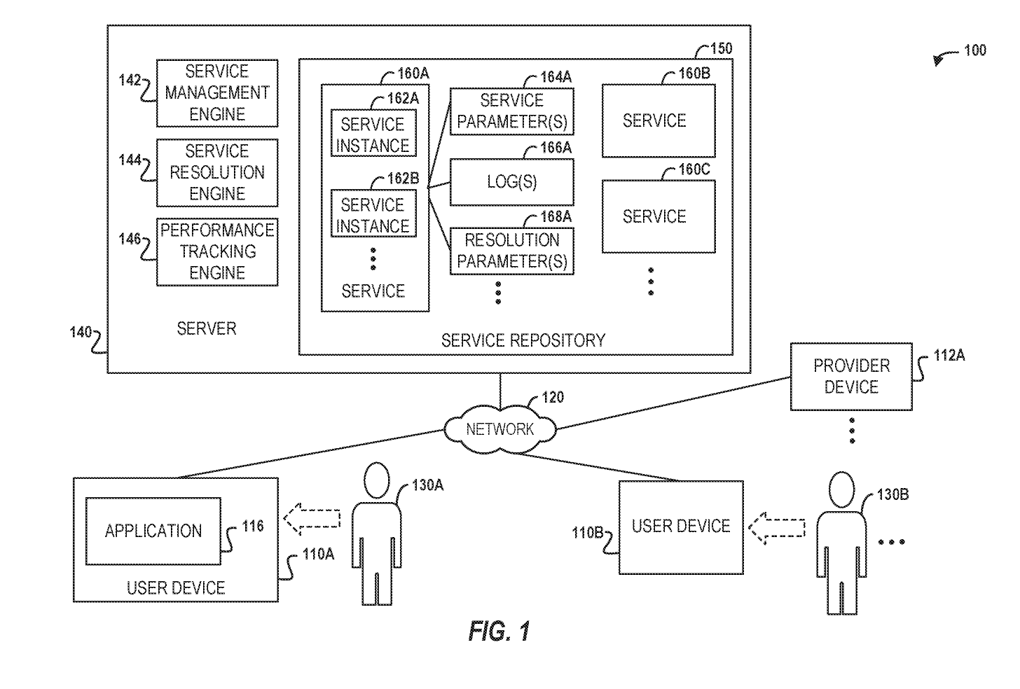

FIG. 1 illustrates an example system 100, in accordance with some implementations. As shown, the system 100 includes various devices such as user device 110A and user device 110B (collectively user device(s) 110). Each user device 110 can be a laptop computer, a desktop computer, a terminal, a mobile phone, a tablet computer, a smart watch, a personal digital assistant (PDA), a digital music player, a server, and the like. User 130A and user 130B (collectively user(s) 130) can each be a human user who interacts with a user device 110 (e.g., user device 110A and user device 110B, respectively). For example, user 130 can provide various inputs (e.g., via an input device/interface such as a keyboard, mouse, touchscreen, etc.) to user device 110. User device 110 can also display, project, and/or otherwise provide content to user 130 (e.g., via output components such as a screen, speaker, etc.).

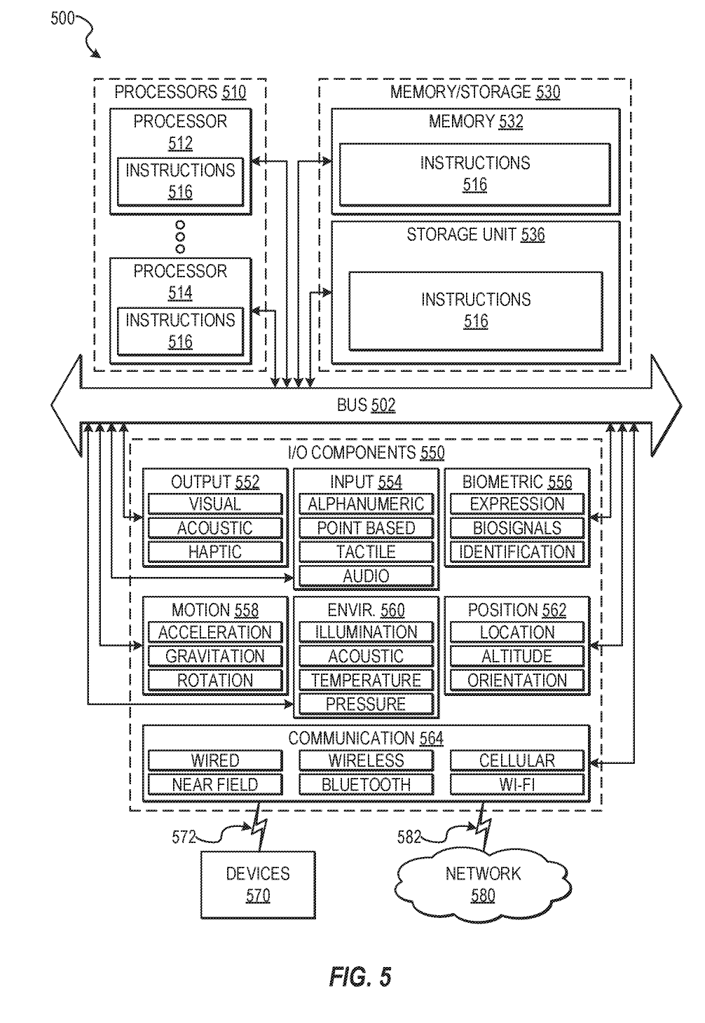

As shown in FIG. 1, user device 110A can include one or more applications such as application 116. Application 116 can be stored in memory of user device 110 (e.g. memory 530 as depicted in FIG. 5 and described below). One or more processor(s) of user device 110 (e.g., processors 510 as depicted in FIG. 5 and described below) can execute such application(s). In doing so, user device 110 can be configured to perform various operations, present content to user 130A, etc. Examples of application(s) 116 include but are not limited to: web browsers, media players, social media/messaging applications, content creation applications, mobile ‘apps,’ etc.

In certain implementations, user device(s) 110 can obtain, receive, etc. application 116 from server 140. As also shown in FIG. 1, devices 110 can connect to and/or otherwise communicate with server 140 via network 120. Network 120 can include one or more networks such as the Internet, a wide area network (WAN), a local area network (LAN), a virtual private network (VPN), an intranet, and the like.

Server 140 can be, for example, a server computer, computing device, storage service (e.g., a ‘cloud’ service), etc. As describe in detail herein, in certain implementations server 140 can provide various services (e.g., via communication(s) to/from user device 110). Such services can, for example, enable user 130A to access, view, or obtain content, media, etc., initiate various transactions, etc. In certain implementations, server 140 can also provide application 116 to user device 110. Such an application can be, for example, a ‘mobile app’ that enables user device 110 (e.g., a smartphone, tablet device, etc.) to access service(s) on server 140 (and/or provides various functionality locally on user device 110).

As shown in FIG. 1, server 140 can include service management engine 142. Service management engine 142 can be an application or module that configures/enables server 140 to perform various operations such as are described herein. For example, service management engine 142 can configure or enable server 140 to manage the deployment of various services 160 (as described in greater detail below). Such services can include application(s), programs, etc., that execute on server 140 and can be accessed by user device(s) 110 (e.g., via a ‘mobile app’ such as application 116, a web browser application, etc.). Accordingly, service management engine 142 can enable server 140 to provide an ‘app store’ through which users can select and gain access to various services (e.g., by downloading application 116 from server 140 and installing it on user device 110). In certain implementations, such services can include subscription-based services in which a user 130A can pay a fee or provide some other form of credit (e.g., at define intervals such as every month) in order to continue accessing the service (and/or aspects, features, etc. thereof). In other implementations, such services can include services in which a user 130A can pay a fee or provide some other form of credit in exchange for ongoing access to the service (and/or aspects, features, etc. thereof). It should be understood that the referenced types of services are provided by way of example and that the described technologies can be employed with respect to any number of other types of services, applications, etc.

The referenced services (and their corresponding application(s) 116) can be provided to server 140 by various developers, administrators, providers, etc. (who create and/or maintain such services/applications). Accordingly, as shown in FIG. 1, provider device 112A can be a computing device, etc., controlled by such a developer (e.g., of a particular service). The developer can provide various services/applications to server 140, and service management engine 142 can then coordinate/manage the dissemination of such application(s) and/or providing access to the corresponding services (e.g., to subscribing users). The developer can also define various service parameters (e.g., service parameter 164A) which reflect, for example, an amount of currency to charge for a particular application, service, feature, etc., the frequency to perform such a charge, etc. Service management engine 142 can also manage aspects associated with payments, etc., provided by user(s) for access to such service(s)/application(s), and an also return a portion of the collected payments to the associated developer. Accordingly, the various technologies described herein can automatically monitor, manage, etc. numerous aspects of the service/application provided by the referenced developer. For example, as described herein, the described technologies can monitor various operations, patterns, etc. of a service and automatically identify deviation(s) from normal/expected operation (e.g., using machine learning techniques). Having identified, for example, a service outage, the described technologies can automatically initiate various resolution(s). In doing so, such incidents can be identified (and resolved) without the direct input of the developer. The developer can thus provide the referenced application/service to server 140, and the described technologies can monitor, manage, etc., numerous aspects of the ongoing operation of the service on behalf of the developer.

As also shown in FIG. 1, in certain implementations server 140 can include service repository 150. Service repository 150 can be a database and/or other computing and/or storage components that store and/or maintain various aspects of the described services, applications, etc. As shown in FIG. 1, service repository 150 can include service 160A, service 160B, and service 160C (collectively, service(s) 160). As described above, users can access services 160 via user devices 110 and/or application(s) (e.g., application 116). As also described above, service management engine 142 can manage/coordinate access to services 160 by user devices 110 (e.g., in accordance with a subscription selected by the user).

In certain implementations service repository 150 can maintain various service instances with respect to a particular service (e.g., service instance 162A and service instance 162A, collectively service instance(s) 162). Each service instance can be, for example, a respective session of a service 160, e.g., as accessed by a particular user or user device. By way of illustration, service instance 162A can be a session of a cloud-based word processing application as accessed by user 130A via user device 110A, while service instance 162B can be a session of the referenced word processing application as accessed by user 130B via user device 110B.

In certain implementations, service repository 150 can also store/maintain various parameters, records, information, etc., in relation to the referenced services 160. For example, as shown in FIG. 1, service 160A can be associated with service parameters 164A. Such service parameters can include, for example, various settings, preferences, etc., that dictate or define aspects of the manner in which service 160A is provided or managed.

For example, such service parameters can include various subscription parameters that define various aspects of a service subscription (such as cost of subscription, frequency of renewal—e.g., monthly, annually, etc.). In certain implementations, such service parameters 164A can be provided by a developer or administrator of the service, e.g., via provider device 112A. For example, a developer can provide (e.g., upload) service 160A (and/or a corresponding application) to server 140, and can define/provide associated service parameter(s) 164A. Such service parameters can dictate the terms, etc., with respect to which service management engine 142 is to distribute and/or provide access to the service.

Additionally, in certain implementations service repository 150 can also store/maintain various log(s) 166A (e.g., in relation to a service such as service 160A). Such a log can be, for example, a database or repository that stores various information, including but not limited to records pertaining to the manner in which a user and/or a user device accesses or otherwise interacts with the associated service. For example, log 166A can maintain a history of a user's access of service 160A. Such a history can reflect, for example, the number of times the user has accessed the service, the function(s) of the service the user has utilized, the amount of subscription fees the user has paid, etc.

Moreover, in certain implementations service repository 150 can also store/maintain resolution parameter(s) 168A (e.g., in relation to a particular service 160A). Such resolution parameter(s) can be, for example, various settings, preferences, etc., that dictate or define aspects of the manner in which various events that occur with respect to service 160A can be addressed, resolved, etc. That is, it can be appreciated that the ability of a user or user device to access or utilize various service(s) can be affected for any number of reasons. For example, application 116 may fail to install properly (or otherwise function) on user device 110A. By way of further example, service 160A and/or server 140 can malfunction, ‘crash,’ become inaccessible, etc. As a result, user(s) (who hold subscriptions to the service) may be unable to access to the service (and/or certain features thereof). Accordingly, the referenced resolution parameter(s) can define various settings, preferences, approaches, etc., through which such events (service interruptions, outages, etc.) can be resolved. In certain implementations, such resolution parameter(s) can be provided or otherwise defined by a developer/administrator of the service, e.g., via provider device 112A.

By way of illustration, in certain implementations the referenced resolution parameter(s) can include or reflect certain forms of credit or compensation that can be provided to a user. For example, a resolution parameter can dictate that a free or discounted month of service should be credited to a user that experiences a particular type of service interruption. By way of further example, a resolution parameter can dictate that a refund of previously paid subscription fees should be issued to the user.

In certain implementations various aspects of the resolution parameters can also be generated, computed, and/or dynamically adjusted, e.g., in various scenarios. For example, as shown in FIG. 1, server 140 includes service resolution engine 144. Service resolution engine 144 can be an application or module that configures/enables server 140 to perform various operations such as are described herein. For example, service resolution engine 144 can configure or enable server 140 to generate various resolution parameter(s) 168A. By way of illustration, a developer/administrator can indicate (e.g., when providing or configuring service 160A at server 140) that certain aspects, values, results, etc., are to be prioritized, e.g., when implementing the described resolution(s) (e.g., in response to service outages, interruptions, etc.).

For example, a developer can indicate that resolution(s) initiated with respect to a particular service are to prioritize customer/subscriber retention. Accordingly, service resolution engine 144 can then generate various resolution parameter(s) for the referenced service which are determined (e.g., based on previous events managed by server 140) to be likely to achieve the referenced result (e.g., retain customers/subscribers after a service interruption/outage). For example, service resolution engine 144 can generate resolution parameter(s) that dictate that user(s) affected by a service outage/interruption are to receive credit(s) toward a free week of service. As noted, such resolution parameter(s) can be generated based on results from previous service interruptions, outages, etc., based upon which it can be determined that users receiving the referenced resolution (e.g., a free week of service) are likely to maintain their subscriptions.

By way of further example, a developer can indicate that resolution(s) initiated with respect to a particular service are to prioritize subscription revenues. Accordingly, service resolution engine 144 can then generate various resolution parameter(s) for the referenced service which can be to be likely to achieve the referenced result. For example, service resolution engine 144 can generate resolution parameter(s) that dictate that user(s) affected by a service outage/interruption are to receive an upgrade (e.g., access to additional feature(s) within the service).

As shown in FIG. 1, server 140 can also include performance tracking interface 146. Performance tracking interface 146 can be an interface, dashboard, reporting tool, etc., that a developer, administrator, etc. of a service can access at server 140 (e.g., via provider device 112A). in certain implementations, performance tracking interface 146 can present, provide, visually depict, etc. the results, ramifications, effectiveness etc. of various actions, resolutions, etc., (e.g., those initiated based on the referenced resolution parameters).

For example, as described herein, the effectiveness of a particular resolution can be determined, e.g., based on subsequent activity by an associated user. By way of illustration, if (after receiving a particular resolution) a user maintains a subscription or provides positive feedback, such activities(s) can indicate that the resolution was effective (and such can be presented in the performance tracking interface). By ways of further illustration, if the user cancels the subscription or provides negative feedback, such can indicate that the resolution was ineffective (and such can be presented in the performance tracking interface). The impact of such resolutions, etc., on the revenues of the developer can also be presented, as described in greater detail below. By presenting such information within the performance tracking interface 146, the developer can review the ramifications, consequences, etc. associated with various resolution parameters, etc., and determine which resolution approaches are best suited for various service(s).

In certain implementations, the described technologies can also compute or determine various aspects, patterns, etc. of normal or expected operation of a particular service and/or the manner in which user(s) interact with such a service. Using various machine learning and/or other such techniques, the described technologies can further process/analyze ongoing operation of/user interaction with the service, e.g., to identify deviation(s) from such normal/expected operation. Such deviation(s) can correspond to events such as service outages, interruptions, crashes, etc. Having identified such a service outage, various actions, resolutions, etc., can be initiated, e.g., with respect to those users affected by the outage, crash, etc., as described herein.

It should be noted that while various components (e.g., service resolution engine 144) are depicted and/or described as operating on a server 140, this is only for the sake of clarity. However, in other implementations the referenced components (e.g., service resolution engine 144) can also be implemented on other devices/machines. For example, in an alternative implementation service management engine 142 can execute on server 140, e.g., to provide an ‘app store’ that provides access to services 160, while service resolution engine 144 executes on another machine (e.g., to provide the various resolution functions described herein).

While various examples described herein are illustrated with respect to a single server (e.g., server 140) and/or device (e.g., device 110A), this is simply for the sake of clarity and brevity. However, it should be understood that the described technologies can also be implemented (in any number of configurations) across multiple devices, servers, services, etc.

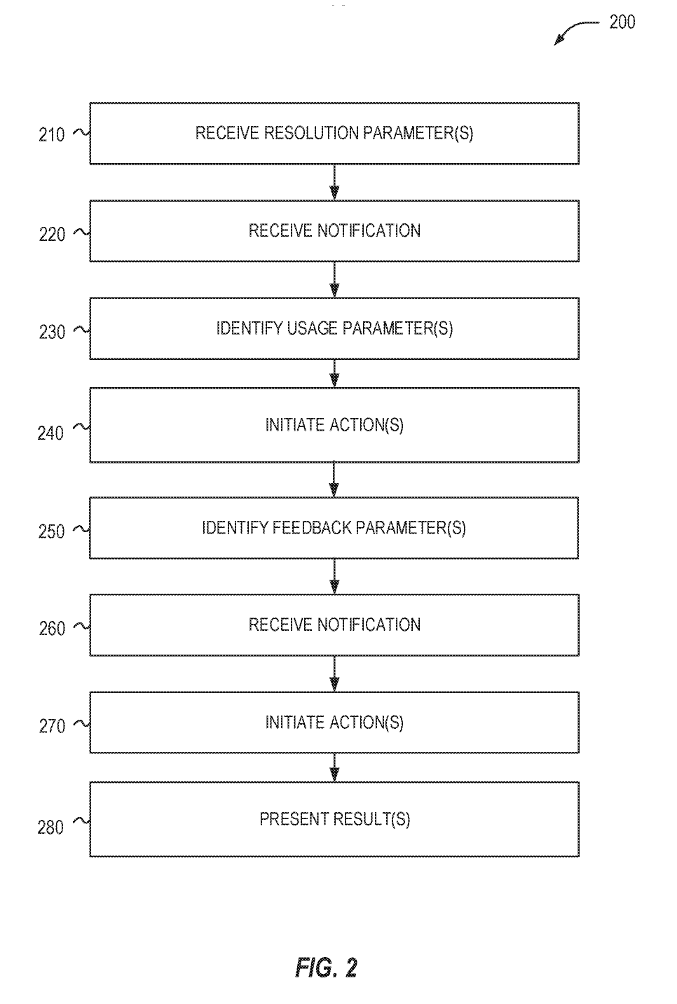

Further aspects and features of server 140 and device(s) 110 are described herein in conjunction with FIGS. 2-5.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

FIG. 2 is a flow chart illustrating a method 200, according to an example embodiment, for automated resolution. The method is performed by processing logic that can comprise hardware (circuitry, dedicated logic, etc.), software (such as is run on a computing device such as those described herein), or a combination of both. In one implementation, the method 200 is performed by one or more elements depicted and/or described in relation to FIG. 1 (including but not limited to server 140), while in some other implementations, the one or more blocks of FIG. 2 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, a resolution parameter (e.g., resolution parameter 168A, as shown in FIG. 1 with respect to service 160A). is received. In certain implementations, such a resolution parameter can be received from a provider, developer, administrator, etc., of a service, application, etc. (e.g., via provider device 112A). As described above such a resolution parameter can include settings, preferences, etc., that define the manner in which events (e.g., outages, disruptions, failures, etc.) that occur with respect to service 160A are to be addressed, resolved, or otherwise responded to. For example, a resolution parameter can reflect that credit, compensation, etc., is to be provided to a user/account that experiences a particular type of service interruption.

In certain implementations, the referenced resolution parameter can include or reflect a resolution framework, approach, etc., such as can be provided by/received from a provider, developer, administrator, etc. of the service. By way of illustration, a developer/administrator can indicate that certain aspects, values, results, etc., are to be prioritized when implementing the described resolution(s) (e.g., in response to service outages, interruptions, etc.). For example, a developer can indicate that resolution(s) initiated with respect to a particular service are to prioritize a result such as subscriber retention. Based on such a framework (e.g., prioritizing subscriber retention), service resolution engine 144 can generate resolution parameter(s) determined to be likely to achieve the referenced result.

For example, service resolution engine 144 can generate resolution parameter(s) that dictate that user(s) affected by a service outage are to receive credit(s) toward a free week, month, etc. of service. In certain implementations, such resolution parameter(s) can be generated based on previous service interruptions, outages, etc. For example, based on resolution(s) provided with respect to previous service interruptions, outages, etc., it can be determined that users receiving the referenced resolution (e.g., a free month of service) are likely to maintain their subscriptions. Accordingly, such a resolution can be further applied in a scenario in which a developer wishes to prioritize subscriber retention.

It should be understood that the various resolution parameters, frameworks, results, resolutions, etc., described herein are provided by way of example. Accordingly, any number of other parameters, values, options, settings, etc., (e.g., providing access to additional features/functionality, prioritizing subscription revenues, etc.) can also be employed with respect to the described technologies.

Additionally, in certain implementations the referenced resolution parameter(s) can be identified, determined, generated, etc., based on/with respect to those provided/received with respect to another service. For example, as shown in FIG. 1, a developer can provide resolution parameter(s) 168 with respect service 160A. Subsequently, upon providing, configuring, etc. another service (e.g., service 160B), the developer can also associate the referenced resolution parameters 168A with such service. In doing so, a developer can, for example, utilize an existing resolution framework across multiple services, applications, etc.

Moreover, as noted above, in certain implementations service resolution engine 144 can generate the referenced resolution parameter(s). For example, upon receiving a service, application, etc., (e.g., from a developer, administrator, etc.), service resolution engine 144 can identify other services, etc., that may be similar or related to the received service (e.g., within the same category, provided by similar developers, etc.). Having identified such related service(s), resolution parameter(s) associated with such related service(s) can also be identified. By way of illustration, it can be determined that several related services provide a free week of service after a service outage. Based on such a determination, service resolution engine 144 can associate the same (or similar) resolution parameters to the newly received service. Alternatively, service resolution engine 144 can suggest or prompt the developer to apply the identified resolution parameters to the referenced service. Such a suggestion (which can be, for example, a message, notification, etc., provided to the developer) can indicate, for example, that developers of similar or related services provide a provide a free week of service after a service outage, etc.

Additionally, in certain implementations service resolution engine 144 can also identify and/or account for the effectiveness of the referenced resolution parameter(s) (e.g., those associated with other services). For example, those resolution parameters associated with services having subscribers that maintain their subscriptions (e.g., for a defined period of time, e.g., six months) after a service outage, etc., can be determined to be effective (e.g., with respect to subscriber retention). By way of further example, those resolution parameters associated with services having subscribers that provide positive feedback, reviews, etc. after experiencing a service outage, etc., can be determined to be effective (e.g., with respect to user satisfaction, etc.). In certain implementations, such feedback, reviews, etc., can be provided with respect to a request or prompt for feedback presented to such subscribers in conjunction with a notification that describes the referenced resolution. Accordingly, service resolution engine 144 can further account for the referenced effectiveness of a resolution parameter (as determined based on results received/observed with respect to other services) when generating resolution parameter(s), e.g., for a newly provided/received service. For example, having determined that certain resolution parameter(s) (e.g., access to additional features of a service) are effective (e.g., with respect to retaining subscribers of a similar/related service), comparable resolution parameter(s) can be suggested to the developer and/or associated with a newly provided/received service.

At operation 220, a notification (e.g., a first notification) is received. In certain implementations, such a notification can be associated with a first service instance (e.g., of a service as provided to a first user). As noted above, in certain implementations such a service instance (e.g., service instance 162A as shown in FIG. 1) can be a session of a service 160A (e.g., a cloud-based service) as accessed by user 130A via user device 110A. Accordingly, the referenced notification can be a message, transmission, communication etc., that reflects an occurrence of an event (e.g., a service outage, failure, etc.), e.g., with respect to a particular service instance (e.g., a session of the service associated with a particular user). In other implementations, the referenced instance can also correspond to an installation of an application at a user device (e.g., user device 110A which can be associated with user 130A as shown in FIG. 1). For example, user 130A can attempt to download (e.g., from server 140) and/or install application 116 (e.g., a mobile app through which service 160A can be accessed). In a scenario in which the application fails to install on device 110A or crashes, malfunctions, etc., a notification, communication, etc. can be provided (e.g., by device 110A), reflecting such an event.

In certain implementations, service resolution engine 144 can receive the referenced notification from user 130A, e.g., via application 116 and/or user device 110A. Such a notification can be, for example, a service interruption notification that reflects that a particular service (or aspects thereof) has been interrupted. In certain implementations, such a service interruption notification can be associated with several users (e.g., when access to an entire service is interrupted) while in other implementations such a notification can be associated with a particular user (e.g., when a single user's access to the service is interrupted).

By way of illustration, upon experiencing a service outage, interruption, etc., user 130A can initiate various communications, actions, etc. For example, user 130A can initiate contact via a customer service framework/portal (e.g., by submitting a request for help to restore access to the referenced service, a request to cancel a subscription, etc.). Based on such communications, the referenced notification(s) can be generated, provided, etc.

In other implementations, service resolution engine 144 can generate or identify the referenced notifications, e.g., based on log 166A. As noted above, log 166A can include or reflect an event history associated with the service. Accordingly, the presence of errors, outages, crashes, etc., can be reflected in log 166A and can be used to generate the referenced notification(s).

In addition to service interruptions, app crashes, etc., the referenced notification can also include or reflect a notification that the manner in which a user utilizes a particular service has changed. For example, in certain scenarios a user may utilize a subscription service during certain times of the year while not utilizing the service (or utilizing it infrequently) at other times (e.g., students who access a research service during the academic year but not during summer months). In certain implementations, a developer, administrator, etc., of the service may wish to identify such users and provide additional subscription credit, etc., to users who are not utilizing a service (or are not utilizing it regularly) over a period of time. In doing so, the referenced subscribers may be more inclined to maintain their subscriptions, having received credit, etc., for time periods when they do not access/utilize the service.

For example, using information from log 166A (reflecting a history of the usage of service 160A by user 130A), service resolution engine 144 can determine or otherwise identify a usage pattern associated with the user (e.g., the user accesses service 160A several times a week over the course of several months). Subsequently, service resolution engine 144 can further determine (e.g., based on log 166A) when usage of service 160A by user 130A deviates or departs from such a usage pattern (e.g., when user 130A does not access the service for several weeks). Accordingly, it can be appreciated that the described technologies can automatically monitor the usage of an application/service by a particular user, and identify deviations from such usage patterns. Additionally, the described technologies can further determine the manner in which such deviations are to be addressed, e.g., by way of various resolution(s), as described herein. In doing so, in lieu of a developer reacting to complaints from customers, subscribers, etc. (or having such subscribers cancel subscriptions, provide negative feedback, etc.), the described technologies can proactively initiate resolutions, such as those determined to be likely to cause users to maintain subscriptions, etc.

At operation 230, a usage parameter is identified. In certain implementations, such a usage parameter can be associated with or otherwise pertain to a particular user. In certain implementations, service resolution engine 144 can identify or otherwise determine such a usage parameter based on information contained within log 166A (which, as noted, reflects a history of the manner in which the user accesses/utilizes the associated service). The referenced usage parameter can be a value that reflects aspects such as the frequency with which the user accesses/uses the service, the manner in which the user utilizes the service (e.g., which features), the amount of revenue generated by the user's utilization of the service, etc. As described herein, the referenced usage parameter can be further utilized or accounted for in determining which resolution parameters to apply when a service interruption, etc., occurs (e.g., what amount of credit, compensation, etc. is to be provided to such a user).

At operation 240, a first action is initiated. In certain implementations, such an action can be initiated (e.g., by service resolution engine 144) in response to receipt of a notification (e.g., at operation 230). For example, upon receipt of a notification that a service interruption has occurred with respect to service instance 162A (e.g., a session of service 160A that is associated with user 130A), an action can be initiated with respect to such a service instance 162A and/or user 130A. Such an action can be, for example, an operation directed to addressing and/or resolving the service outage, interruption, etc., that occurred (e.g., providing credit, compensation, upgrades, additional features, etc. to the affected subscriber). In certain implementations, the referenced action can be initiated based on various resolution parameters (e.g. as received at operation 210). As described above, resolution parameter(s) can define the manner in which such events (e.g., service outages, disruptions, etc.) are to be addressed or resolved.

By way of illustration, in certain implementations the referenced action can include adjusting various service parameters, e.g., with respect to a particular instance of a service (e.g., an instance associated with a particular user). As noted above, such service parameters can include settings, preferences, etc., that dictate aspects of the manner in which a service is provided or managed. For example, such service parameters include but are not limited to various functions, features, levels, etc. associated with a service, various subscription parameter(s) that define aspects of a service subscription (e.g., frequency/cost of renewal), etc. Accordingly, adjusting a service parameter can, for example, include providing a user with access to additional/upgraded features, functionality, etc. within the service. By way of further example, by adjusting a subscription parameter a user can be provided with additional subscription credits (e.g., a free week of service), a refund of fees paid, etc.

In certain implementations, a user can also be notified of such adjustments. For example, a message, user notification, etc. can be generated and provided to the referenced user. Such a user notification can reflect or otherwise indicate aspects of the resolution being provided. For example, a user notification, message, etc. that reflects aspect of an adjustment to a service parameter (e.g., that the user is being provided with a service upgrade/access to additional features within the service) and/or a subscription parameter (e.g., that the user is being credited with a free month of service) can be generated and/or provided.

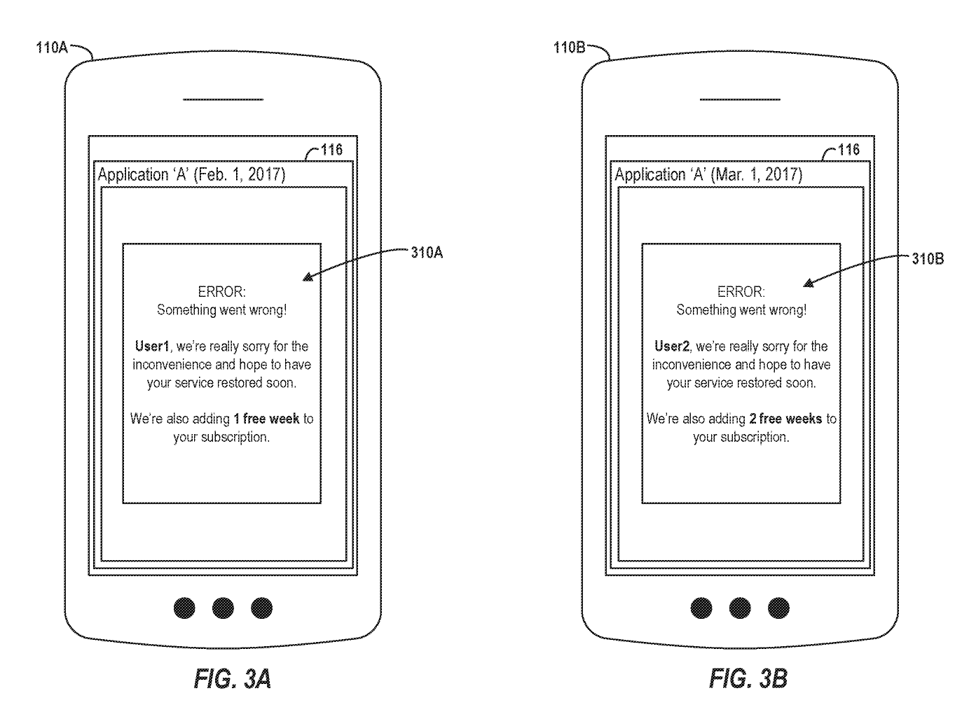

By way of illustration, FIG. 3A depicts an example scenario in which user 130A accesses service 160A via application 116 executing on user device 110A. As shown in FIG. 3A, when a service outage occurs, message/user notification 310A can be provided to device 110A. Such a message 310A can reflect the referenced action, e.g., the resolution being provided to the user (here. ‘adding 1 free week’ to the subscription of user 130A to service 160A).

Moreover, in certain implementations the referenced action(s) can be initiated based on various usage parameter(s) (e.g., as identified/received at operation 230). As noted above, such usage parameter(s) can reflect the manner, frequency, etc. in which a user utilizes a service. For example, the referenced usage parameter can be further utilized or accounted for in determining the action to be initiated when a service interruption, etc., occurs. By way of illustration, in certain implementations one set of resolution parameters (e.g., access to additional features) can be applied when a service interruption, etc., occurs with respect to a user that has been a subscriber for more than six months, while other resolution parameters (e.g., a free month of service) can be applied with respect to a subscriber of less than six months. Additionally, as noted above, different resolution parameters can be applied to different events (e.g., service outages, failure of an application to install, etc.).

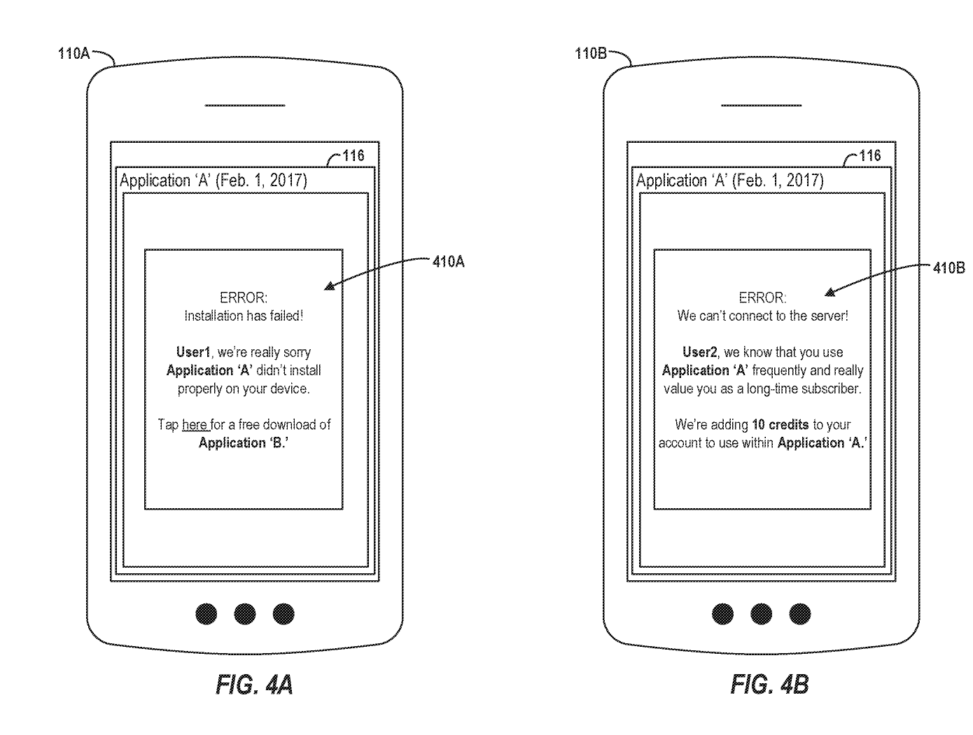

By way of illustration. FIG. 4A depicts an example scenario in which user 130A attempts to install application 116 (‘Application ‘A’) on user device 110A (e.g., in order to access service 160A). As shown in FIG. 4A, when such an installation failure occurs, message/user notification 410A can be provided to device 110A. Such a message 410A can reflect the referenced action, e.g., the resolution being provided to the user (here, providing the user with a free download of another application, such as another application—here, ‘Application ‘B’ provided by the same developer). Doing so can be advantageous, for example, in a scenario where the user is a new user to the referenced service and may be quick to try another service instead when encountering initial installation problems. Accordingly, by providing the user with a free download of another application (‘Application ‘B’) provided by developer, the developer can attempt to maintain the interest, relationship. etc. with the user (e.g., with respect to the second application/service).

By way of further illustration, FIG. 4B depicts an example scenario in which user 130B attempts to access service 160A via application 116 executing on user device 110B. As reflected in FIG. 4B user 130B is a frequent user and long-time subscriber of service 160A. Accordingly, when a service outage occurs, a resolution determined to be applicable/effective with respect to other comparable users (e.g., other long-time/frequent users) can be provided to user 130B. For example, as reflected in message/user notification 410B, user 130B can be provided with additional credits that can be used within service 160A, e.g., to purchase additional features.

Moreover, in certain implementations a resolution of an aspect of the service can be prioritized. For example, certain interruptions, outages, crashes, etc., can be identified or determined to be particularly disruptive, detrimental, etc., (e.g., to a developer/administrator of the associated service). For example, the referenced developer can maintain or utilize a queue or other such task management application in order to track various items, features, etc., within a service that are to be fixed, improved, updated, etc. Accordingly, having identified various frequently recurring interruptions, outages that affect many users, crashes that cause significant revenue losses, etc., the resolution of such items can be prioritized within the referenced queue. In doing so, the developer can be alerted that resolving such items (e.g., restoring services that have crashed, etc.) are high priority tasks.

In certain implementations, service resolution engine 144 can also deactivate or otherwise disable, modify, etc., various aspects, features, etc., of a service. For example, having identified a particular feature of a service as the source of interruptions, crashes, etc. (e.g., those that are particularly disruptive, detrimental, etc.), such a feature can be disabled or deactivated. A developer associated with the service can also be notified, informed, etc., of such deactivation, in order to enable the developer to correct, resolve, etc. the referenced feature. By deactivating feature(s) that cause crashes, etc., subsequent service interruptions can be prevented and users can continue to access other feature(s) of the service.

At operation 250, a feedback parameter is identified. In certain implementations, such a feedback parameter can be identified with respect to a user such as a user with respect to which the notification was received (e.g., at operation 220). Such a feedback parameter can include or reflect, for example, a review, rating, etc., provided by the referenced user with respect to the service. By way of illustration, a user of a service can experience a service outage, installation failure, etc., and, in response, the described technologies can initiate various resolution action(s) (e.g., based on resolution parameters, etc.). Subsequently, the referenced user can provide (e.g., to server 140) feedback, ratings, etc. with respect to the referenced service/application (e.g., within an ‘app store’ interface in which users provide feedback regarding their experiences with various services/applications). Accordingly, the feedback parameter(s) provided by such a user in such a scenario can reflect the degree to which the referenced resolution parameter(s) were (or were not) effective in addressing/resolving the referenced service interruption.

For example, in a scenario in which a subscriber experiences a service interruption, receives a free week of subscription credit, and subsequently provides favorable feedback for the service, it can be determined that the referenced resolution (here, a free week of subscription credit) was likely an effective resolution. Moreover, having identified such a resolution as being effective, service resolution engine 144 can utilize (and/or suggest the utilization of, e.g., to other developers) corresponding resolution parameters, e.g., with respect to other users and/or other services (e.g., in comparable scenarios, such as with respect to comparable service interruptions, etc.). By way of further example, in a similar scenario in which a user does not provide favorable feedback, it can be determined that the referenced resolution may not be an effective resolution (and it may therefore be preferable to utilize other resolution parameters).

At operation 260, a second notification is received. Such a notification can be associated with a second service instance (e.g., instance 162B of service 160A as provided to user 130B via device 110B, as shown in FIG. 1). Such a service instance can be a session of a service that is provided to/accessed by another user (e.g., a different user from the user referenced above with respect to operation 220). As described above, the referenced notification can be a message, transmission, communication, etc., reflecting an occurrence of an event (e.g., a service outage, crash, etc.) with respect to the referenced service instance. For example, service resolution engine 144 can receive a notification that a service interruption has occurred with respect to service instance 162B (which is associated with user 130B).

At operation 270, a second action is initiated. Such an action can be initiated (e.g., by service resolution engine 144) in response to receipt of a notification (e.g., at operation 260) while further accounting for previous actions that have been initiated (e.g., at operation 240). For example, upon receiving a notification that a service interruption has occurred with respect to service instance 162B, an action (e.g., an operation that responds to the outage, interruption, etc.) can be initiated. In certain implementations, such an action can be initiated (e.g., with respect to service instance 162B) based on the results, effectiveness, etc., of previous actions (e.g., an action initiated with respect to service instance 162A, as described at operation 240).

By way of illustration, in certain implementations the results, effectiveness, etc. of a particular action/resolution can be identified or determined based on subsequent activity by the associated user. For example, one type of resolution (e.g., providing a free week of subscription credit) can be provided to one user in response to a service outage. Subsequent activity by such a user can then be used to determine whether such a resolution was effective (e.g., with respect to satisfying the user after the service outage). For example, if the user maintains his/her subscription for several additional months, this can indicate that the resolution was effective (while the user canceling the subscription can indicate that the resolution was not effective). Accordingly, such a determination of effectiveness can be further accounted for in determining a resolution to be provided to another user. It may be advantageous to utilize those resolution(s) that are determined to be effective (e.g., with respect to maintaining service subscriptions, providing positive feedback, etc.) while avoiding resolution(s) determined (e.g., with respect to previous instances) not to be effective.

By way of further example, the referenced feedback parameters (e.g., as received at operation 250) can also be accounted for in determining an action/resolution to initiate. For example, as described above, a particular action (e.g., providing a free week of service) can be initiated with respect to a first user (e.g., in response to a service interruption). Such a first user can then provide feedback parameter(s) (e.g., a rating, review, etc.) that can reflect a degree of effectiveness of the referenced action/resolution. Based on such effectiveness, a similar/comparable action (or, alternatively, a different action) can be utilized in response to a scenario in which a second user experiences a service interruption, etc. In doing so, the experiences, feedback, etc., from previous users/scenarios can be used to improve subsequent responses/resolutions.

For example, FIG. 3B depicts an example scenario in which user 130B experiences a service interruption (on Mar. 1, 2017) that is comparable to the service interruption previously experienced by user 130A (on Feb. 1, 2017), as depicted in FIG. 3A. As shown in FIG. 3A and described above, the resolution provided to user 130A was adding ‘1 free week’ to the user's subscription. However, as described above, in certain scenarios such an action/resolution can be determined not to be effective, e.g., based on subsequent activity by the user (e.g., if the user subsequently cancels their subscription, provides a negative review, etc.). Accordingly, in a scenario in which the referenced action/resolution provided with respect to user 130A as shown in FIG. 3A (adding one free week to a subscription) is determined to be ineffective, in a subsequent scenario another action/resolution can be applied instead. For example, as shown in FIG. 3B, when a comparable service interruption occurs (e.g., with respect to user 130B), another action/resolution can be utilized (e.g., adding two free weeks to a subscription). In doing so, the described technologies can account for previous results in order to provide a resolution that is likely to satisfy the user and/or further the goals, objectives, etc. of the developer (e.g., customer retention, etc.).

At operation 280, various result(s) can be presented, e.g., to a provider of the service. Such results can reflect or include results of various actions (e.g., those initiated at operation 240 and/or operation 270). In certain implementations, such result(s) can be presented within a performance tracking interface. As noted above, performance tracking interface 146 can be a graphical user interface (GUI), dashboard, reporting tool, etc., that a developer, administrator, etc. of a service can access at server 140 (e.g., via provider device 112A). Such a performance tracking interface can provide/present information to the developer that reflects the results, ramifications, etc., of various actions/resolutions being employed.

By way of illustration, performance tracking interface 146 can present information reflecting the effectiveness of various action(s) (e.g., those initiated at operation 240 and/or operation 270). For example, activities performed by a user after receiving a resolution (e.g., a free week of service) can reflect or indicate the effectiveness of the resolution. By way of illustration, a user maintaining a subscription or providing positive feedback can reflect that the resolution was effective. By way of further illustration, a user canceling a subscription or providing negative feedback can reflect that the resolution was ineffective. Such results can be presented within performance tracking interface, thereby enabling the developer to review the results, effectiveness, of various resolution parameters.

Additionally, in certain implementations performance tracking interface 146 can provide/present information that reflects the impact of various actions/resolutions on the revenues generated on behalf of the developer (e.g., by various services). For example, in a scenario in which the referenced action/resolution includes providing a refund to affected users, the performance tracking interface can present information reflecting how such refunds have impacted the revenues generated by the service.

Moreover, in certain implementations, various projections, predictions, etc. can be computed. Such projections can reflect, for example, future results that are expected to occur. For example, in a scenario in which the referenced action/resolution includes providing a free month of service to affected users, various projections, predictions, etc., can be computed, reflecting the manner in which such an action is likely to impact future revenues. By way of illustration, in a scenario in which numerous subscribers have been awarded a free month of service, revenues generated in the next month (during which such subscribers are receiving free service) can be projected to be likely to decline. In future month(s), such revenues can be further projected to be likely to increase (being that such subscribers will likely resume paying for their subscriptions). By presenting such information, projections, etc. within performance tracking interface, the developer can review the ramifications, consequences, etc. associated with various resolution parameters, actions, etc., and determine which resolution approaches are best suited for various service(s).

It should also be noted that while the technologies described herein are illustrated primarily with respect to automated resolution, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-4 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 5 is a block diagram illustrating components of a machine 500, according to some example implementations, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein can be executed. The instructions 516 transform the general, non-programmed machine into a particular machine programmed to carry out the described and illustrated functions in the manner described. In alternative implementations, the machine 500 operates as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 can include processors 510, memory/storage 530, and I/O components 550, which can be configured to communicate with each other such as via a bus 502. In an example implementation, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 512 and a processor 514 that can execute the instructions 516. The term “processor” is intended to include multi-core processors that can comprise two or more independent processors (sometimes referred to as “cores”) that can execute instructions contemporaneously. Although FIG. 5 shows multiple processors 510, the machine 500 can include a single processor with a single core, a single processor with multiple cores (e.g., a multi-core processor), multiple processors with a single core, multiple processors with multiples cores, or any combination thereof.

The memory/storage 530 can include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 can also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 can include a wide variety of components to receive input, provide output, produce output, transmit information, exchange information, capture measurements, and so on. The specific 1/O components 550 that are included in a particular machine will depend on the type of machine. For example, portable machines such as mobile phones will likely include a touch input device or other such input mechanisms, while a headless server machine will likely not include such a touch input device. It will be appreciated that the 1/O components 550 can include many other components that are not shown in FIG. 5. The I/O components 550 are grouped according to functionality merely for simplifying the following discussion and the grouping is in no way limiting. In various example implementations, the 1/O components 550 can include output components 552 and input components 554. The output components 552 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 550 can include biometric components 556, motion components 558, environmental components 560, or position components 562, among a wide array of other components. For example, the biometric components 556 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 can include acceleration sensor components (e.g., accelerometer), gravitation sensor components, rotation sensor components (e.g., gyroscope), and so forth. The environmental components 560 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 562 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 550 can include communication components 564 operable to couple the machine 500 to a network 580 or devices 570 via a coupling 582 and a coupling 572, respectively. For example, the communication components 564 can include a network interface component or other suitable device to interface with the network 580. In further examples, the communication components 564 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 can be another machine or any of a wide variety of peripheral devices (e.g., a peripheral device coupled via a USB).

Moreover, the communication components 564 can detect identifiers or include components operable to detect identifiers. For example, the communication components 564 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 564, such as location via Internet Protocol (IP) geolocation, location via Wi-Fi® signal triangulation, location via detecting an NFC beacon signal that can indicate a particular location, and so forth.

In various example implementations, one or more portions of the network 580 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 can include a wireless or cellular network and the coupling 582 can be a Code Division Multiple Access (CDMA) connection, a Global System for Mobile communications (GSM) connection, or another type of cellular or wireless coupling. In this example, the coupling 582 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 can be transmitted or received over the network 580 using a transmission medium via a network interface device (e.g., a network interface component included in the communication components 564) and utilizing any one of a number of well-known transfer protocols (e.g., HTTP). Similarly, the instructions 516 can be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a first notification associated with a first instance of a service as provided to a first user;
in response to receipt of the first notification, initiating a first action with respect to the first instance of the service as provided to the first user;
receiving a second notification associated with a second instance of the service as provided to a second user; and
based on the first action initiated with respect to the first instance of the service as provided to the first user, initiating, in response to receipt of the second notification, a second action with respect to the second instance of the service as provided to the second user.

2. The system of claim 1, wherein receiving the first notification comprises receiving the first notification in response to a service request initiated by the first user.

3. The system of claim 1, wherein the memory further stores instructions for causing the system to perform operations comprising receiving, from a provider of the service, a resolution parameter.

4. The system of claim 3, wherein receiving the resolution parameter comprises identifying the resolution parameter with respect to another service.

5. The system of claim 3, wherein initiating the first action comprises initiating the first action based on the resolution parameter.

6. The system of claim 1, wherein the memory further stores instructions for causing the system to perform operations comprising identifying, with respect to the first user, a usage parameter.

7. The system of claim 6, wherein initiating the first action comprises initiating the first action based on the usage parameter.

8. The system of claim 1, wherein the first notification comprises a service interruption notification associated with the first user.

9. The system of claim 1, wherein the first notification comprises a notification that usage of the service by the first user deviates from a usage pattern of the service associated with the first user.

10. The system of claim 1, wherein the first instance of the service as provided to the first user comprises an installation of an application at a device associated with the first user.

11. The system of claim 1, wherein initiating the first action comprises adjusting a subscription parameter with respect to the first instance of the service as provided to the first user.

12. The system of claim 11, wherein initiating the first action further comprises transmitting a message to the first user that reflects an aspect of an adjustment to the subscription parameter.

13. The system of claim 1, wherein initiating the first action comprises adjusting a service parameter with respect to the first instance of the service as provided to the first user.

14. The system of claim 1, wherein initiating the first action comprises prioritizing a resolution of an aspect of the service based on the first notification.

15. A method comprising:
receiving a first notification associated with a first instance of a service as provided to a first user;
in response to receipt of the first notification, initiating a first action with respect to the first instance of the service as provided to the first user;
receiving a second notification associated with a second instance of the service as provided to a second user; and
based on the first action initiated with respect to the first instance of the service as provided to the first user, initiating, in response to receipt of the second notification, a second action with respect to the second instance of the service as provided to the second user.

16. The method of claim 15, wherein initiating the first action comprises deactivating an aspect of the service based on the first notification.

17. The method of claim 15, further comprising: identifying, with respect to the first user, a feedback parameter, and wherein initiating the second action comprises initiating the second action based on the feedback parameter.

18. A non-transitory computer readable medium having instructions stored thereon that, when executed by a processing device, cause the processing device to perform operations comprising:
receiving a first notification associated with a first instance of a service as provided to a first user;
in response to receipt of the first notification, initiating a first action with respect to the first instance of the service as provided to the first user;
receiving a second notification associated with a second instance of the service as provided to a second user; and
based on the first action initiated with respect to the first instance of the service as provided to the first user, initiating, in response to receipt of the second notification, a second action with respect to the second instance of the service as provided to the second user.

19. The computer-readable medium of claim 18, wherein the medium further stores instructions for causing the processing device to perform operations comprising presenting within a performance tracking interface, a first result of the first action with respect to a provider of the service.

20. The computer-readable medium of claim 19, wherein presenting the first result of the first action further comprises:
projecting, based on the first action and the second action, a second result with respect to a provider of the service; and
presenting the second result within the performance tracking interface.
